(19) United States
(12) Patent Application Publication
(10) Pub. No.: US 2020/0080372 A1
(43) Pub. Date: Mar. 12, 2020

(54) BLIND CAPABLE OF STEPLESS POSITIONING

(71) Applicant: CHING FENG HOME FASHIONS CO., LTD., FUXING TOWNSHIP (TW)

(72) Inventors: Sheng-Ying HSU, FUXING TOWNSHIP (TW); Wen-Ying LIANG, FUXING TOWNSHIP (TW); Wu-Chung NIEN, FUXING TOWNSHIP (TW)

(21) Appl. No.: 16/185,605

(22) Filed: Nov. 9, 2018

(30) Foreign Application Priority Data
Sep. 11, 2018 (TW) 107212393

(51) Int. Cl. E06B 9/44

(52) U.S. Cl. CPC E06B 9/44

(57) ABSTRACT

A blind capable of stepless positioning includes a control unit which controls the positioning of a shade, is disposed in a roller, and has a fixed sleeve, a spindle, a movable sleeve and a pre-torque spring. The fixed sleeve is fixedly disposed at a roller holder and fitted around one end of the spindle, whereas the movable sleeve is fixedly disposed at the roller and fitted around the other end of the spindle; hence, the movable sleeve rotates together with the roller. The pre-torque spring is fitted around the spindle and has two ends connected to the fixed sleeve and the movable sleeve, respectively, such that the pre-torque spring operates in conjunction with the movable sleeve. While the shade is being rolled up and rolled down, a predetermined torque level of the pre-torque spring matches the length of the shade to therefore brake the shade at any height.

### FIELD OF THE INVENTION

The present disclosure relates to blinds and, more particularly, to a blind capable of stepless positioning, which is structurally simple and cheap to manufacture.

### BACKGROUND OF THE INVENTION

Depending on their control systems, conventional blinds are of various categories: roller shades, Roman shades, pleated blinds, Venetian blinds, etc. The roller shade is a window shade mounted on a roller. The roller is rotated clockwise and counterclockwise with a cord or bead chain which a user exerts a force on, so as to raise and lower the shade.

To allow the ascending or descending shade to stop instantly at a height anticipated by the user, the prior art discloses a brake mounted inside the roller. As soon as the user stops exerting a force on the cord or bead chain, the brake applies a stopping force to the roller instantly to stop the roller from rotating, and thus the shade is positioned in place. However, the brake renders the roller structurally complicated. As a result, conventional roller shades are not only inconvenient to assemble/disassemble but also expensive to manufacture.

### BRIEF SUMMARY OF THE INVENTION

It is an objective of the present disclosure to provide a blind capable of stepless positioning. The blind capable of stepless positioning is structurally simple and cheap to manufacture, because it has a pre-torque spring for exerting a pre-torque on a shade to stop the shade from ascending or descending. Furthermore, the pre-torque of the pre-torque spring and the weight of a counterweight bar are two opposing forces at work.

In order to achieve the above and other objectives, the present disclosure provides in the first embodiment thereof a blind capable of stepless positioning, comprising a roller holder, a roller, a shade, a counterweight bar and a control unit. The roller is rotatably disposed in the roller holder. The top edge of the shade is connected to the roller, whereas the bottom edge of the shade is connected to the counterweight bar; hence, in the course of the pulling of the shade, the shade drives the roller to rotate. Owing to the rotation of the roller, the shade is wound on the roller or let out from the roller. The control unit is disposed in the roller and has a fixed sleeve, a spindle, a movable sleeve and a pre-torque spring. The fixed sleeve is fixed to one end of the roller holder. One end of the spindle is fixed to the fixed sleeve. The movable sleeve is connected to the roller and rotatably fitted around the other end of the spindle such that the movable sleeve can operate in conjunction with the roller. The pre-torque spring is fitted around the spindle. One end of the pre-torque spring is fixed to the fixed sleeve. The other end of the pre-torque spring is fixed to the movable sleeve such that the pre-torque spring can operate in conjunction with the movable sleeve.

Therefore, in the course of rolling up and rolling down the shade, the pre-torque of the pre-torque spring matches the length of the shade, and thus the shade can be positioned at any height, so as to dispense with a brake otherwise required by the prior art, simplify structure, and cut manufacturing costs.

Preferably, the roller holder has a first end cover. The first end cover has a first polygonal protruding portion. The fixed sleeve has a first polygonal hole. The first polygonal hole of the fixed sleeve is engaged with the first polygonal protruding portion of the first end cover. Hence, the fixed sleeve cannot rotate.

Preferably, an inner circumferential surface of the roller has a rib, whereas an outer circumferential surface of the movable sleeve has a first dent portion. The first dent portion of the movable sleeve is engaged with the rib of the roller, and thus the movable sleeve operates in conjunction with the roller.

Furthermore, the present disclosure further provides in the second embodiment thereof another blind capable of stepless positioning, comprising the roller holder, the roller, the shade, the counterweight bar, the control unit and a transmission unit. The roller holder, the roller, the shade, the counterweight bar and the control unit in the second embodiment are identical to their counterparts in the first embodiment. The transmission unit is disposed at one end of the roller holder and has a first transmission element and a second transmission element. The first transmission element has a first bevel gear and a first transmission shaft connected to the first bevel gear. The second transmission element has a second bevel gear and a second transmission shaft connected to the second bevel gear. The first bevel gear of the first transmission element meshes with the second bevel gear of the second transmission element. The second transmission shaft of the second transmission element is connected to one end of the roller, and thus the second transmission element drives the roller to rotate.

Preferably, blind capable of stepless positioning further comprises a drive rod with a top end having a hook portion. The first transmission shaft of the first transmission element has a hook hole. The hook portion of the drive rod is separably hooked to the hook hole of the first transmission shaft of the first transmission element.

Therefore, if the blind capable of stepless positioning is too high for the user to operate the shade by hand, the user can rotate the drive rod to therefore drive the first transmission element to rotate together with the drive rod. Hence, in the course of its rotation, the first transmission element meshes with and drives the second transmission element, and thus the second transmission element drives the roller to rotate together with the second transmission element, thereby rolling up and rolling down the shade.

Preferably, the roller holder has a second bushing. The second bushing has a second polygonal hole. The second polygonal hole of the second bushing is engaged with the second transmission shaft of the second transmission element. An outer circumferential surface of the second bushing has a second dent portion. The second dent portion of the second bushing is engaged with the rib of the roller. Therefore, when driven by the second transmission element, the second bushing drives the roller to rotate as well.

Fine structures, features, assembly and operation of the blind capable of stepless positioning, provided by the present disclosure, are described in detail below. However, persons skilled in the art understand that the detailed description and specific embodiments illustrative of the present disclosure are descriptive of the present disclosure rather than restrictive of the claims of the present disclosure.

### BRIEF DESCRIPTION OF THE SEVERAL VIEWS OF THE DRAWINGS

FIG. 1 is a perspective view of a blind capable of stepless positioning according to the first embodiment of the present disclosure;

FIG. 2 is an exploded view of the blind capable of stepless positioning according to the first embodiment of the present disclosure;

FIG. 3 is a cross-sectional view of the blind capable of stepless positioning assembled according to the first embodiment of the present disclosure;

FIG. 4 is a cross-sectional view of the blind capable of stepless positioning taken along line 4-4 of FIG. 3;

FIG. 5 is a perspective view of another blind capable of stepless positioning according to the second embodiment of the present disclosure;

FIG. 6 is a partial exploded view of the blind capable of stepless positioning according to the second embodiment of the present disclosure; and

FIG. 7 is a cross-sectional view of the blind capable of stepless positioning according to the second embodiment of the present disclosure, showing the structural relationship between a roller, a second bushing and a second transmission element.

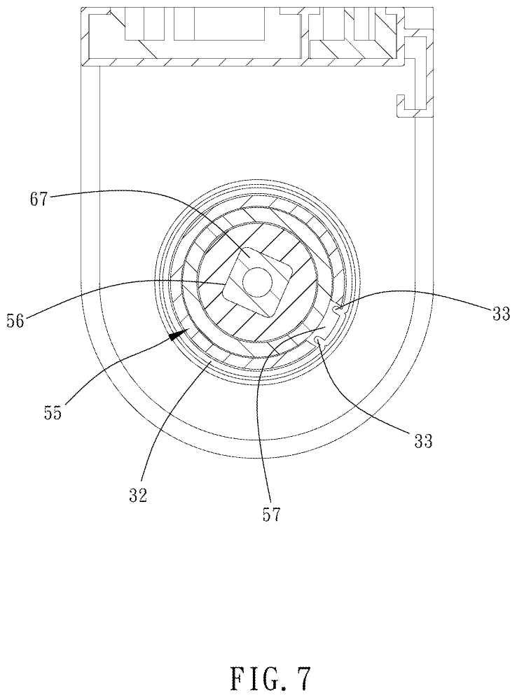

### DETAILED DESCRIPTION OF THE INVENTION

In embodiments below and accompanying drawings, identical reference numerals denote identical or similar components or structural features thereof.

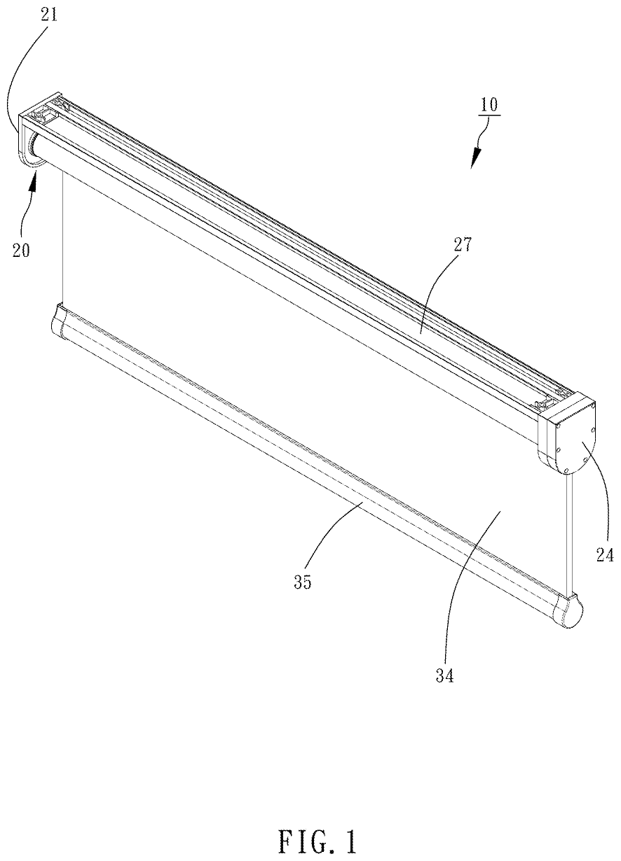

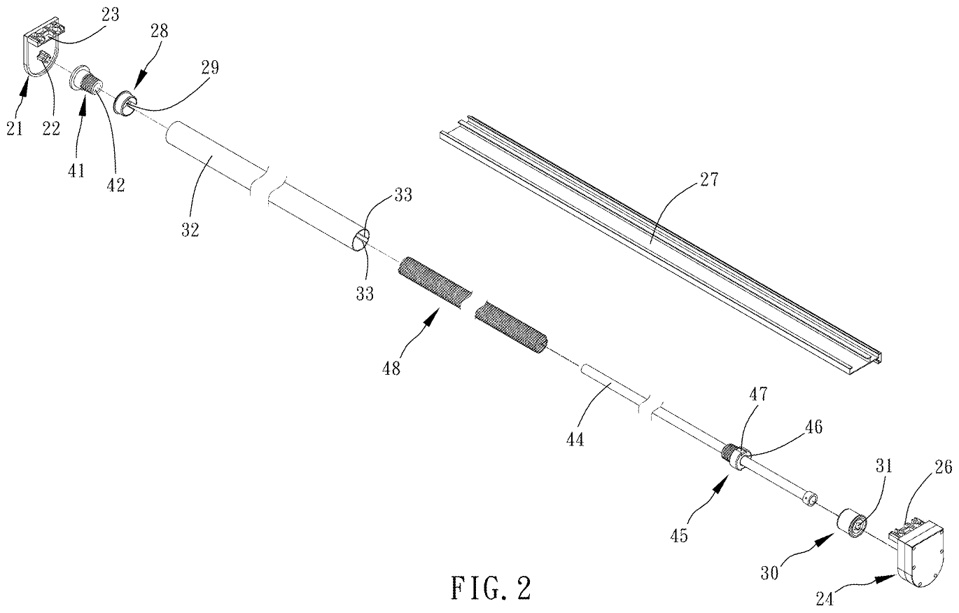

Referring to FIGS. 1, 2, a blind capable of stepless positioning 10 according to the first embodiment of the present disclosure comprises a roller holder 20, a roller 32, a shade 34, a counterweight bar 35 and a control unit 40.

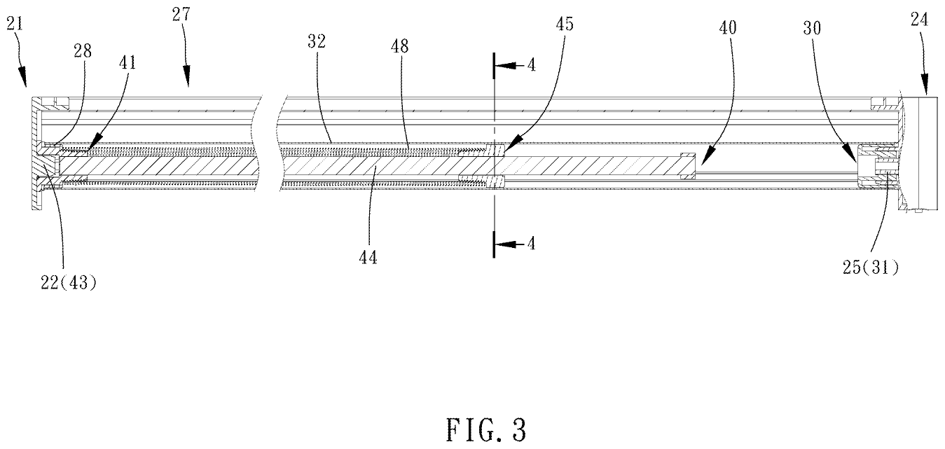

The roller holder 20 has a first end cover 21, a second end cover 24 and a top panel 27. The inner end surface of the first end cover 21 has a first polygonal protruding portion 22 and a first engaging portion 23 disposed above the first polygonal protruding portion 22. The inner end surface of the second end cover 24 has a second polygonal protruding portion 25 (shown in FIG. 3) and a second engaging portion 26 disposed above the second polygonal protruding portion 25. Two ends of the top panel 27 are engaged with the first engaging portion 23 of the first end cover 21 and the second engaging portion 26 of the second end cover 24, respectively. The roller holder 20 further has a first bushing 28 and a second bushing 30. The first bushing 28 has a round hole 29. The second bushing 30 has a second polygonal hole 31. The second polygonal hole 31 of the second bushing 30 is engaged with the second polygonal protruding portion 25 of the second end cover 24 (as shown in FIG. 3).

As shown in FIGS. 2, 3, the roller 32 is disposed below the top panel 27 of the roller holder 20. One end of the roller 32 is fitted into the first bushing 28, and the other end of the roller 32 is fitted into the second bushing 30, thereby allowing the roller 32 to rotate relative to the roller holder 20. Furthermore, the inner circumferential surface of the roller 32 has two ribs 33 parallel to each other. The two ribs 33 extend in a direction parallel to the axial direction of the roller 32.

The top edge of the shade 34 is connected to the roller 32, and the bottom edge of the shade 34 is connected to the counterweight bar 35; hence, not only can the shade 34, while being rolled up and rolled down under a force exerted by the user, drive the roller 32 to rotate, but the shade 34 can also be wound on the roller 32 and let out from the roller 32 because of the clockwise and counterclockwise rotation of the roller 32, respectively.

The control unit 40 is disposed in the roller 32 and has a fixed sleeve 41, a spindle 44, a movable sleeve 45 and a pre-torque spring 48.

One end of the fixed sleeve 41 has a first axial hole 42. The other end of the fixed sleeve 41 has a first polygonal hole 43. The first polygonal hole 43 of the fixed sleeve 41 is engaged with the first polygonal protruding portion 22 (shown in FIG. 3) of the first end cover 21 of the roller holder 20; hence, the fixed sleeve 41 cannot rotate. Furthermore, the round hole 29 of the first bushing 28 of the roller holder 20 is fitted around the fixed sleeve 41.

One end of the spindle 44 is insertedly fixed to the first axial hole 42 of the fixed sleeve 41. The other end of the spindle 44 is separated from the second end cover 24 by a predetermined distance.

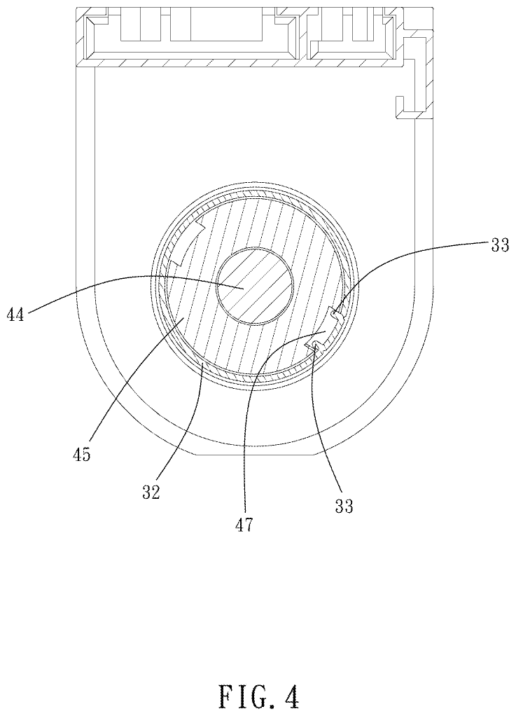

The movable sleeve 45 has a second axial hole 46. The second axial hole 46 of the movable sleeve 45 is rotatably fitted around the spindle 44. Furthermore, the outer circumferential surface of the movable sleeve 45 has a first dent portion 47, and thus the first dent portion 47 of the movable sleeve 45 is engaged with the two ribs 33 of the roller 32, as shown in FIGS. 3, 4, such that the movable sleeve 45 rotates together with the roller 32.

The pre-torque spring 48 generates a pre-torque beforehand. To select the pre-torque spring 48 for use, a manufacturer of the blind capable of stepless positioning 10 follows the steps below: determining parameters, namely dimensions of the shade 34, material which the shade 34 is made of, weight of the counterweight bar 35, and height at which the shade 34 is to be positioned at; and calculating the required torque level with the parameters. Afterward, to mount the pre-torque spring 48 in place, the manufacturer of the blind capable of stepless positioning 10 follows the steps below: fitting the pre-torque spring 48 which has not yet generated a pre-torque around the spindle 44 such that the two ends of the pre-torque spring 48 are fixed to the fixed sleeve 41 and the movable sleeve 45, respectively; rotating the movable sleeve 45 until it has an appropriate number of turns required to allow the pre-torque spring 48 to generate a pre-torque while being driven by the movable sleeve 45; sensing immediately the pre-torque generated from the pre-torque spring 48 with a torque sensor and adjusting the pre-torque of the pre-torque spring 48 until the pre-torque reaches the aforesaid calculated torque level; and positioning the movable sleeve 45 while the first dent portion 47 of the movable sleeve 45 is being engaged with the ribs 33 of the roller 32.

Therefore, the shade 34 drives, while being rolled up and rolled down under a force exerted by the user, the roller 32 to rotate; then, the roller 32 drives the movable sleeve 45 and the pre-torque spring 48 to rotate together. As soon as the user stops exerting the force on the shade 34, not only does the pre-torque of the pre-torque spring 48 brake the shade 34, but the pre-torque of the pre-torque spring 48 and the weight of the counterweight bar 35 also become two opposing forces at work to therefore allow the shade 34 to be positioned at any height.

The present disclosure further provides in the second embodiment thereof a blind capable of stepless positioning 12. The blind capable of stepless positioning 12 comprises a transmission unit 60 and a drive rod 70 which operate jointly to drive the roller 32. Except for a roller holder 50 in the second embodiment, the second embodiment is identical to the first embodiment in technical features.

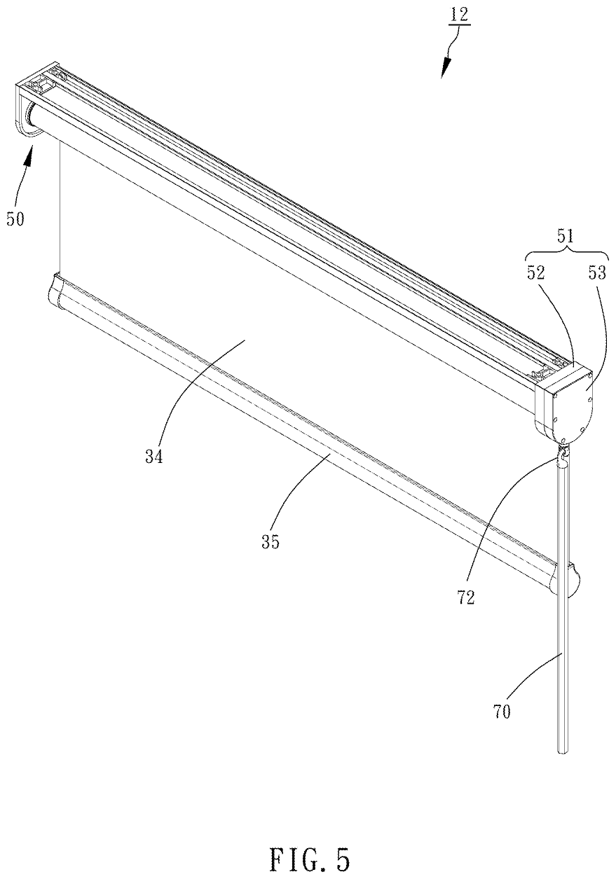

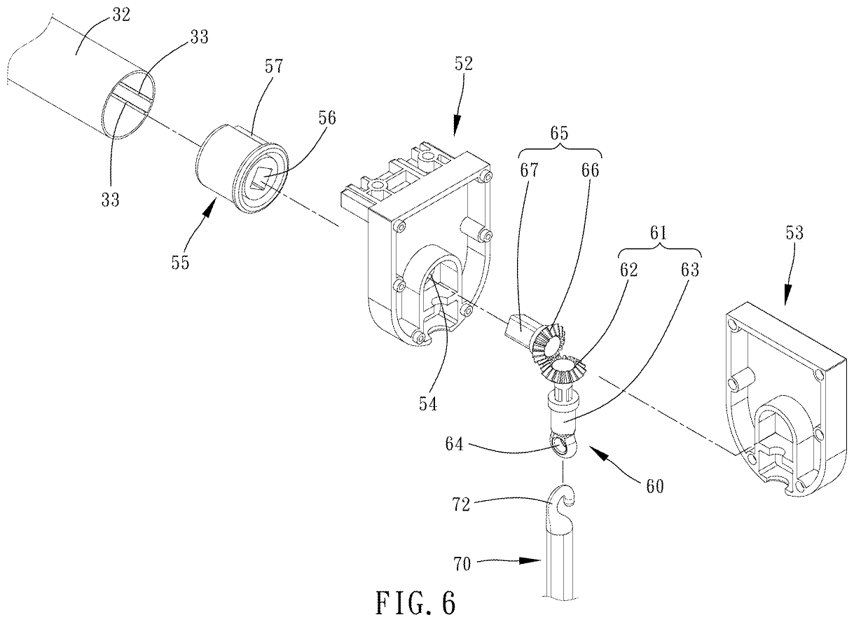

As shown in FIGS. 5, 6, a second end cover 51 of the roller holder 50 comprises an inner covering plate 52 and an outer covering plate 53 which are connected. The inner covering plate 52 has a through hole 54. The through hole 54 of the inner covering plate 52 corresponds in position to a second polygonal hole 56 of a second bushing 55 of the roller holder 50. Furthermore, the outer circumferential surface of the second bushing 55 of the roller holder 50 has a second dent portion 57. The second dent portion 57 of the second bushing 55 is engaged with the two ribs 33 of the roller 32 such that the second bushing 55 can rotate together with the roller 32.

The transmission unit 60 is disposed inside the second end cover 51 of the roller holder 50. The transmission unit 60 has a first transmission element 61 and a second transmission element 65. The first transmission element 61 has a first bevel gear 62 and a first transmission shaft 63. One end of the first transmission shaft 63 is fitted around the body of the first bevel gear 62. The other end of the first transmission shaft 63 is exposed from the second end cover 51 and has a hook hole 64. The second transmission element 65 has a second bevel gear 66 and a second transmission shaft 67. The second bevel gear 66 of the second transmission element 65 meshes with the first bevel gear 62 of the first transmission element 61. One end of the second transmission shaft 67 is integrally connected to the second bevel gear 66. The other end of the second transmission shaft 67 is engaged with the second polygonal hole 56 of the second bushing 55 through the through hole 54 of the inner covering plate 52 of the second end cover 51 such that the second transmission element 65 rotates together with the second bushing 55.

The top end of the drive rod 70 has a hook portion 72 hooked to the hook hole 64 of the first transmission shaft 63 of the first transmission element 61, and thus the drive rod 70 drives the first transmission element 61 to rotate.

Therefore, if the blind capable of stepless positioning 12 is too high for the user to operate the shade by hand, the user can rotate the drive rod 70 to therefore drive the shade 34 to rise and lower. To rotate the drive rod 70, the user hooks the hook portion 72 of the drive rod 70 to the hook hole 64 of the first transmission shaft 63 of the first transmission element 61 and then exerts a force for rotating the drive rod 70. The rotation of the first transmission element 61 causes the first bevel gear 62 of the first transmission element 61 to mesh with and drive the second bevel gear 66 of the second transmission element 65. Afterward, the second transmission shaft 67 of the second transmission element 65 drives the second bushing 55 to rotate, and thus the second bushing 55 drives the roller 32 to rotate. The rotation of the roller 32 causes the shade 34 to roll up and roll down.

In conclusion, the blinds capable of stepless positioning 10, 12 according to the present disclosure employ the pre-torque of the pre-torque spring 48 to brake the shade 34. The pre-torque of the pre-torque spring 48 and the weight of the counterweight bar 35 are two opposing forces at work. Therefore, the present disclosure dispenses with a brake otherwise required by the prior art, simplifies structure, and cuts manufacturing costs.

What is claimed is:

1. A blind capable of stepless positioning, consisting of:
a roller holder;
a roller rotatably disposed in the roller holder;
a shade having a top edge connected to the roller;
a counterweight bar connected to a bottom edge of the shade; and
a control unit disposed in the roller and having a fixed sleeve, a spindle, a movable sleeve and a pre-torque spring, the fixed sleeve being fixed to an end of the roller holder and an end of the spindle, the movable sleeve being connected to the roller and rotatably fitted around another end of the spindle, and the pre-torque spring being fitted around the spindle, having an end fixed to the fixed sleeve, and having another end fixed to the movable sleeve.

2. The blind capable of stepless positioning according to claim 1, wherein the roller holder has a first end cover, a second end cover and a top panel, the first end cover being fixedly connected to the fixed sleeve, the second end cover being separated from the spindle by a predetermined distance, and the top panel being connected to the first and second end covers and disposed above the roller.

3. The blind capable of stepless positioning according to claim 2, wherein the first end cover has a first polygonal protruding portion, and the fixed sleeve has a first polygonal hole, such that the first polygonal hole of the fixed sleeve is engaged with the first polygonal protruding portion of the first end cover.

4. The blind capable of stepless positioning according to claim 2, wherein the roller holder further has a first bushing and a second bushing, the first bushing being disposed between an end of the roller and the fixed bushing, and the second bushing being disposed between another end of the roller and the second end cover.

5. The blind capable of stepless positioning according to claim 4, wherein the second end cover has a second polygonal protruding portion, and the second bushing has a second polygonal hole, such that the second polygonal hole of the second bushing is engaged with the second polygonal protruding portion of the second end cover.

6. The blind capable of stepless positioning according to claim 1, wherein an inner circumferential surface of the roller has a rib, and an outer circumferential surface of the movable sleeve has a first dent portion, such that the first dent portion of the movable sleeve is engaged with the rib of the roller.

7. A blind capable of stepless positioning, comprising:
a roller holder;
a roller rotatably disposed in the roller holder;
a shade having a top edge connected to the roller;
a counterweight bar connected to a bottom edge of the shade;
a control unit disposed in the roller and having a fixed sleeve, a spindle, a movable sleeve and a pre-torque spring, the fixed sleeve being fixed to an end of the roller holder and an end of the spindle, the movable sleeve being connected to the roller and rotatably fitted around another end of the spindle, wherein the pre-torque spring is fitted around the spindle, has an end fixed to the fixed sleeve, and has another end fixed to the movable sleeve; and
a transmission unit disposed at an end of the roller holder and having a first transmission element and a second transmission element, the first transmission element having a first bevel gear and a first transmission shaft connected to the first bevel gear, and the second transmission element having a second bevel gear and a second transmission shaft connected to the second bevel gear, wherein the first bevel gear of the first transmission element meshes with the second bevel gear of the second transmission element, and the second transmission shaft of the second transmission element is connected to an end of the roller.

8. The blind capable of stepless positioning according to claim 7, wherein the roller holder has a first end cover, a second end cover and a top panel, the first end cover being fixedly connected to the fixed sleeve, the second end cover being separated from the spindle by a predetermined distance and sheltering the transmission unit, and the top panel being connected to the first and second end covers and disposed above the roller.

9. The blind capable of stepless positioning according to claim 8, wherein the first end cover has a first polygonal protruding portion, and the fixed sleeve has a first polygonal hole, such that the first polygonal hole of the fixed sleeve is engaged with the first polygonal protruding portion of the first end cover.

10. The blind capable of stepless positioning according to claim 8, wherein the roller holder further has a first bushing and a second bushing, the first bushing being disposed between an end of the roller and the fixed bushing, and the second bushing being disposed between another end of the roller and the second end cover to connect to the first transmission shaft of the first transmission element.

11. The blind capable of stepless positioning according to claim 10, wherein an inner circumferential surface of the roller has a rib, and an outer circumferential surface of the second bushing has a second dent portion, such that the second dent portion of the second bushing is engaged with the rib of the roller.

12. The blind capable of stepless positioning according to claim 10, wherein the second bushing has a second polygonal hole, and the second polygonal hole of the second bushing is engaged with the second transmission shaft of the second transmission element.

13. The blind capable of stepless positioning according to claim 7, wherein an inner circumferential surface of the roller has a rib, and an outer circumferential surface of the movable sleeve has a first dent portion, such that the first dent portion of the movable sleeve is engaged with the rib of the roller.

14. The blind capable of stepless positioning according to claim 7, further comprising a drive rod with a top end having a hook portion, wherein the first transmission shaft of the first transmission element has a hook hole such that the hook portion of the drive rod is separably hooked to the hook hole of the first transmission shaft of the first transmission element.

15. The blind capable of stepless positioning according to claim 8, further comprising a drive rod with a top end having a hook portion, wherein the first transmission shaft of the first transmission element has a hook hole such that the hook portion of the drive rod is separably hooked to the hook hole of the first transmission shaft of the first transmission element.

16. The blind capable of stepless positioning according to claim 9, further comprising a drive rod with a top end having a hook portion, wherein the first transmission shaft of the first transmission element has a hook hole such that the hook portion of the drive rod is separably hooked to the hook hole of the first transmission shaft of the first transmission element.

17. The blind capable of stepless positioning according to claim 10, further comprising a drive rod with a top end having a hook portion, wherein the first transmission shaft of the first transmission element has a hook hole such that the hook portion of the drive rod is separably hooked to the hook hole of the first transmission shaft of the first transmission element.

18. The blind capable of stepless positioning according to claim 11, further comprising a drive rod with a top end having a hook portion, wherein the first transmission shaft of the first transmission element has a hook hole such that the hook portion of the drive rod is separably hooked to the hook hole of the first transmission shaft of the first transmission element.

19. The blind capable of stepless positioning according to claim 12, further comprising a drive rod with a top end having a hook portion, wherein the first transmission shaft of the first transmission element has a hook hole such that the hook portion of the drive rod is separably hooked to the hook hole of the first transmission shaft of the first transmission element.

20. The blind capable of stepless positioning according to claim 13, further comprising a drive rod with a top end having a hook portion, wherein the first transmission shaft of the first transmission element has a hook hole such that the hook portion of the drive rod is separably hooked to the hook hole of the first transmission shaft of the first transmission element.
